(19) United States
(12) Patent Application Publication
(10) Pub. No.: US 2026/0235109 A1
(43) Pub. Date: Aug. 13, 2026

(54) HIGH VISIBILITY TIP PROTECTOR COVER

(71) Applicant: DANSK GUMMI INDUSTRI A/S, Kolding (DK)

(72) Inventors: Peter KRONBERG THOMSEN, Kolding (DK); Carsten SOMMER, Odense M (DK)

(21) Appl. No.: 19/156,263

(22) PCT Filed: Feb. 22, 2024
(86) PCT No.: PCT/DK2024/050034

§ 371 Date: Aug. 13, 2025

(30) Foreign Application Priority Data
Feb. 24, 2023 (DK) PA 2023 70104
Apr. 27, 2023 (DK) PA 2023 70207
May 30, 2023 (DK) PA 2023 70266

(51) Int. Cl. F03D 13/40

(52) U.S. Cl. CPC F03D 13/401; F05B 2260/02

(57) ABSTRACT

The present invention relates a protective cover (10) for protecting one or more fragile edges or a tip of an elongated unit (2) with an upper face and a lower face, wherein said protective cover (10) is made of a resilient material and comprises an inner surface (60) adapted to be mounted in contact with said upper and lower face and an outer upper surface (70) and outer lower surface (71) facing outwards and away from the inner surface (60), wherein the protective cover is adapted to extend beyond said edges or tip of the elongated unit, wherein said protective cover comprises at least one through-going hole or slit extending from the outer upper surface (70) to the outer lower surface (71), said through-going holes (40) or slits being adapted to receive a strap (50) for removably fastening the protective cover (10) to the elongated unit (2) by frictional forces between the inner surface (60) and the upper and/or lower face by applying force to the outer upper surface (70) and/or outer lower surface (71).

### CROSS REFERENCE TO RELATED APPLICATIONS

This application is a national stage of PCT Application No. PCT/DK2024/050034, having a filing date of Feb. 22, 2024, which is based on DK Application Nos. PA 2023 70266, having a filing date of May 30, 2023, PA 2023 70207, having a filing date of Apr. 27, 2023 and PA 2023 70104, having a filing date of Feb. 24, 2023, the entire contents all of which are hereby incorporated by reference.

### FIELD OF TECHNOLOGY

The following relates to the field of protecting fragile tips of wind turbine wings during transport, storage and otherwise handling of the wind turbine wings.

The fragile tips are protected by providing a protective cover, which is arranged on the tip and fastened to the tip by a strap.

### BACKGROUND

Protection and visual indication of tips of wind turbine wings is important, in order to ensure that the fragile tips are not damaged under transport and/or storage.

Existing solutions are typically made of a foam material provided with cut-outs adapted for specific tips and fastened to the tip with a strap. However, due to the tip-specific adapted cut-outs, the existing solutions are loosely fastened to varying tip shapes and sizes and often fall off during transport or storage.

In other scenarios the straps on the existing solutions are overtightened and may damage the edges of the fragile tip.

Due to the poor fit of the existing solutions, transport crews are required to tape the protective covers onto the fragile tips, however strong adhesive may damage the paintwork of the fragile tips.

### SUMMARY

An aspect relates to a protective cover which provides good protection of the fragile tips of elongated units, e.g., wind turbine wings.

Another aspect is to achieve a protective cover which is properly fastened to the tip, without damaging the tip during the process of tightening the cover to the tip.

Another aspect is to achieve a protective cover which is highly visible, such that no unintended contact is made with the fragile tip during e.g., transport or storage of the elongated unit.

An aspect of embodiments of the invention is achieved by a protective cover for a fragile tip of an elongated unit, the protective cover comprises an inner shell made of a resilient material and an outer shell comprising a rigid or semi rigid material, the protective cover is adapted to be mounted with the inner shell surrounding the tip and in contact with the tip, and with the outer shell forming an upper and outer lower surface the protective cover comprises at least two through-going holes or slits extending from the upper surface to the lower surface of the outer shell, the holes or slits are adapted to receive a strap for removably fastening the protective cover to the tip by frictional forces between the tip and the inner shell by applying force to the outer shell.

One advantageous effect of the two-shell design, i.e., the inner shell is made of a resilient material and the outer shell comprises a rigid or semi rigid material, is that the pressure of fastened strap is distributed throughout the outer shell and thus is provided on a flat surface of the fragile tip, instead of directly on one or more edges of the fragile tip. Thus, the protective cover may be properly fastened to the tip without risk of overtightening and thereby ensuring that the protective cover does not fall off e.g., during transport due to vibrations and/or wind and air resistance.

One further advantage of the inner shell being made of a resilient material is that the inner shell adheres to the tip due to frictional forces.

In an embodiment of the protective cover, the protective cover is made in a single material throughout the inner shell and outer shell, the single material may be a resilient material such as polyurethane (PUR). In one aspect of this embodiment, the material may be internally reinforced with a hard material in a longitudinal extend and/or across the width of the protective cover. The internal reinforcement may also be a mesh or crossed pattern for providing extra reinforcement. The hard material of the internal reinforcement may comprise a plastic, metal or wooden material or be a composite material. The internal reinforcement may be placed in certain parts of the protective cover e.g., where the pressure of the fastened strap is located, or throughout the protective cover to provide a uniform distribution of reinforcement.

In an embodiment of the protective cover, the protective cover is adapted to hold a visual indicator.

One advantage of providing a visual indicator is that the fragile tip is easy to detect, e.g., during transport where the tip may extend beyond a part of a vehicle or during storage where a small and/or thin tip is not easy to detect.

In an embodiment of the protective cover, the protective cover comprises fastening means for fastening one or more second visual indicators in a vertical direction above or below the tip.

The fastening means may be the through-going holes or slits already provided in the protective cover, or the fastening means may be loops or eyelets arranged on the outer shell.

One advantage of providing one or more second visual indicators in a vertical direction above or below the tip, is that if the tip during transport or storage is generally placed below or above a general field of view, the second visual indicators arranged vertically can indicate that the tip is respectively below or above the second visual indicators.

In an embodiment the second visual indicators may be a line marking strip, band, tape or rope. The second visual indicators may be free-hanging or may be attached to a part of a transport vehicle, a pylon, the protective cover of another wing or any other fastening means in vicinity of the protective cover. The second visual indicator may also be arranged in a horizontal direction, e.g., between two adjacent tips provided with protective covers.

In an embodiment of the protective cover, the visual indicator comprises a reflective material.

One advantage of the visual indicator or second visual indicator comprising a reflective material, is that it is easy to detect during any light of day condition be it daybreak, daylight, sunset, evening and/or night.

In an embodiment of the protective cover, the visual indicator comprises a fluorescent material.

The fluorescent material may be a single color or a mix of different colors, e.g., in a striped or circular pattern.

One advantage of the visual indicator or second visual indicator comprising a fluorescent material, is that it is a striking color which is highly visible and may alert and increase awareness of surrounding personnel of the visual indicator and the object covered by the visual indicator.

In an embodiment of the protective cover, the visual indicator comprises one or more light sources.

The light source may be a continuous light in one or more colours of light, or it may be a rotating and/or blinking light in one or more colours of light. The light source may be attached to the protective cover via fastening means such as bolts and nuts, by clamping or by being glued onto the protective cover.

One advantage of the visual indicator comprising one or more light sources, is that the visibility of the tip is further improved, and overall safety is thus improved during transport and/or storage.

In an embodiment of the protective cover, the protective cover comprises an upper shell part and a lower shell part.

One advantage of the protective cover comprising an upper shell part and a lower shell part, is that a single protective cover is suitable to cover and protect many different tips in various dimensions and shapes.

One further advantage is that if an upper shell part or lower shell part is damaged during handling or degrades due to wear and tear, a single upper or lower shell part of the protective cover may be replaced instead of the entire protective cover.

In an embodiment of the protective cover, the inner shell is made of polyurethane (PUR). The material of the inner shell may comprise hollow sections, the hollow sections are designed to make the inner shell more deformable and thus ensures the inner shell will conform to the shape of the fragile tip and thereby increasing the tight hold of the protective cover onto the fragile tip.

In an embodiment of the protective cover, an end-stop is arranged on the protective cover configured for protecting a longitudinal end of the tip.

In an embodiment of the protective cover, the end-stop is configured with a visual indicator and above disclosed embodiments' herein of the visual indicator.

In an embodiment of the protective cover, the protective cover is adapted for covering one or more trailing and/or leading edges or a tip of the elongated unit, the protective cover is made of a resilient material and comprises an inner surface adapted to be mounted in contact with the upper and lower face, and an outer upper surface and outer lower surface facing outwards and away from the inner surface, wherein the protective cover is adapted to extend beyond the edges or tip of the elongated unit, wherein the protective cover comprises at least one through-going hole or slit extending from the outer upper surface to the outer lower surface, the through-going holes or slits being adapted to receive a strap for removably fastening the protective cover to the elongated unit by frictional forces between the inner surface and the upper and/or lower face by applying force to the outer upper surface and/or outer lower surface.

In an embodiment of the protective cover, the protective cover is adapted to cover one or more longitudinal sides and/or edges of the elongated unit. The longitudinal lengths and/or edges may be a leading edge and/or a trailing edge of the elongated unit e.g., a wind turbine blade.

In an embodiment, the protective cover is configured with an upper shell part and a lower shell part for covering two opposite sides or edges of the elongated unit respectively. The upper shell part and the lower shell part are therefore configured to cover the edges and conform to the shape of the edges. In this manner, the upper shell part and the lower shell part are configured to meet and join together adjacent to the edge of the elongated unit, thereby covering and protecting the edge.

One advantage of the protective cover comprising an upper shell part and a lower shell part, is that a single protective cover is suitable to cover and protect many different tips in various dimensions and shapes. Similarly, two shell parts of different sizes and shapes may also be fastened together and onto the sides or edges of the elongated unit.

One further advantage is that if an upper shell part or lower shell part is damaged during handling or degrades due to wear and tear, a single upper or lower shell part of the protective cover may be replaced instead of the entire protective cover.

In an embodiment of the protective cover, the protective cover comprises an inner shell made of the resilient material and an outer shell comprising a rigid or semi rigid material, where the outer shell forms the outer upper surface and outer lower surface, whereby the strap removably fastens the protective cover to the elongated unit by frictional forces between the edges or the tip of the elongated unit and the inner shell by applying force to the outer shell.

One effect of providing an outer shell comprising a rigid or semi rigid is that when the one or more straps applies pressure onto the outer shell, the pressure is evenly distributed into all of the inner shell including the parts not directly covered by a strap, thus increasing how well the protective cover is held onto the edge and/or tip of the elongated unit.

In an embodiment of the protective cover, the resilient material is reinforced with internal reinforcement. The internal reinforcement comprises a rigid or semi rigid material for increasing the durability and strength of the resilient material.

One effect of configuring the resilient material with internal reinforcement is that the protective cover has increased durability and may obtain a stronger hold onto the elongated unit by distributing the clamping force of the strap throughout the resilient material. As the clamping force is distributed throughout the resilient material, the elongated unit is also further protected from damage due to overtightening or extended clamping pressure of the strap.

In an embodiment of the protective cover, the internal reinforcement is a plastic, metal, wood and/or a composite material.

In an embodiment of the protective cover, the internal reinforcement is arranged in a direction parallel and/or perpendicular with a longitudinal direction of the elongated unit.

In an embodiment of the protective cover, the internal reinforcement is arranged in a mesh pattern.

In an embodiment of the protective cover, the protective cover comprises one or more visual indicators.

In an embodiment of the protective cover, the one or more visual indicators comprises a reflective material, a fluorescent material and/or one or more light sources.

One advantage of the visual indicator comprising a reflective or fluorescent material, is that it is easy to detect during any light of day condition be it daybreak, daylight, sunset, evening and night.

The light sources may be a continuous light in one or more colours of light, or it may be a rotating and/or blinking light in one or more colours of light. The light source may be attached to the protective cover via fastening means such as bolts and nuts, by clamping or by being glued onto the protective cover.

One advantage of the visual indicator comprising one or more light sources, is that the visibility of the elongated unit is further improved, and overall safety is thus improved during transport and storage.

In an embodiment of the protective cover covering the longitudinal sides and/or edges of the elongated unit, the protective cover is configured with one or more visual indicators and above disclosed embodiments' herein of the visual indicator.

In an embodiment of the protective cover, the protective cover comprises an upper shell part and a lower shell part, wherein the upper shell part and the lower shell part are configured to be arranged opposite each other with the elongated unit placed in-between the two parts.

In an embodiment, the upper shell part and the lower shell part are joined along the edges of the elongated unit when covering two respective sides of the elongated unit, or there may be a space provided between the two parts when the protective covers are arranged around the edges of the elongated unit.

In an embodiment of the protective cover, the resilient material is polyurethane (PUR).

One effect of the resilient material being polyurethane is that the material provides a strong protection for the covered object and by providing air pillows or air cushions inside the resilient material, the protective cover can further withstand impact which would otherwise be transferred onto the protected object. The air pillows or air cushions inside the resilient material may also protect the elongated unit from damage by overtightening the fastening straps.

### BRIEF DESCRIPTION

Some of the embodiments will be described in detail, with references to the following Figures, wherein like designations denote like members, wherein:

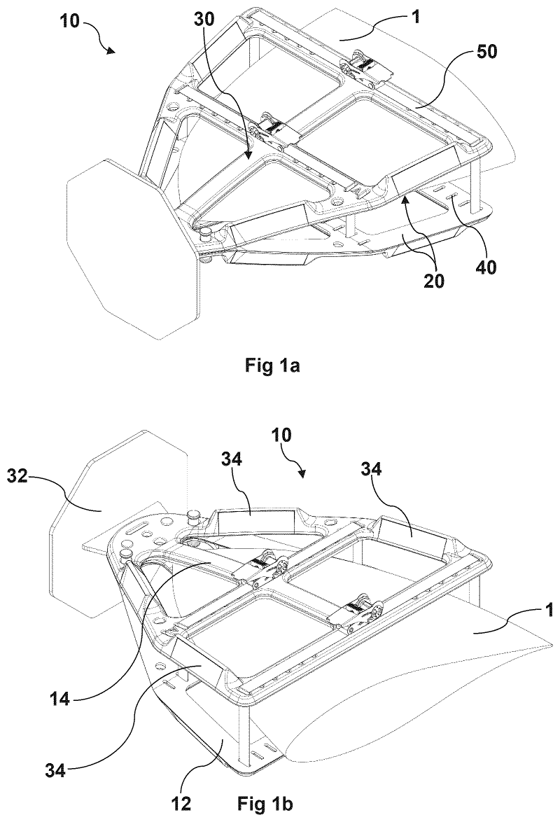

FIG. 1a illustrates an embodiment of a protective cover fastened onto a tip of an elongated unit;

FIG. 1b illustrates a rear view of an embodiment of a protective cover fastened onto a tip;

FIG. 1c illustrates a top/bottom view of an embodiment of a protective cover fastened onto a tip;

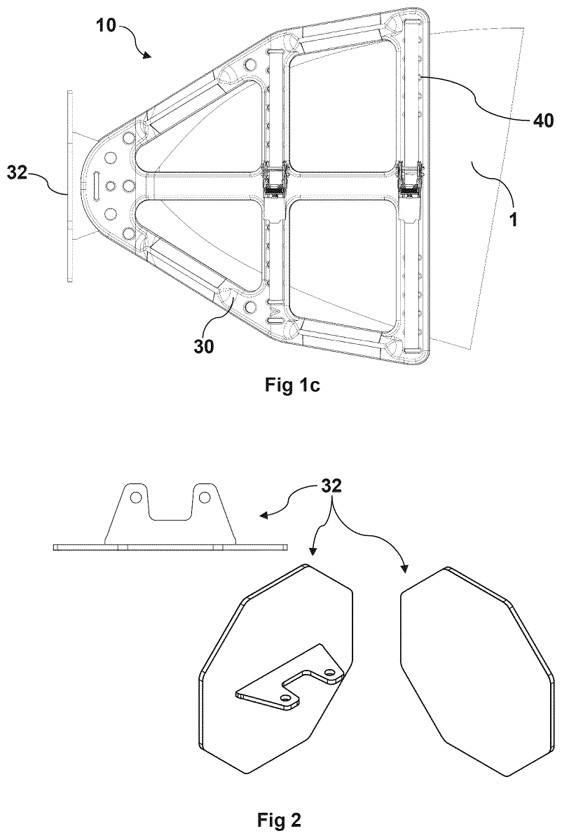

FIG. 2 illustrates an embodiment of an end-stop;

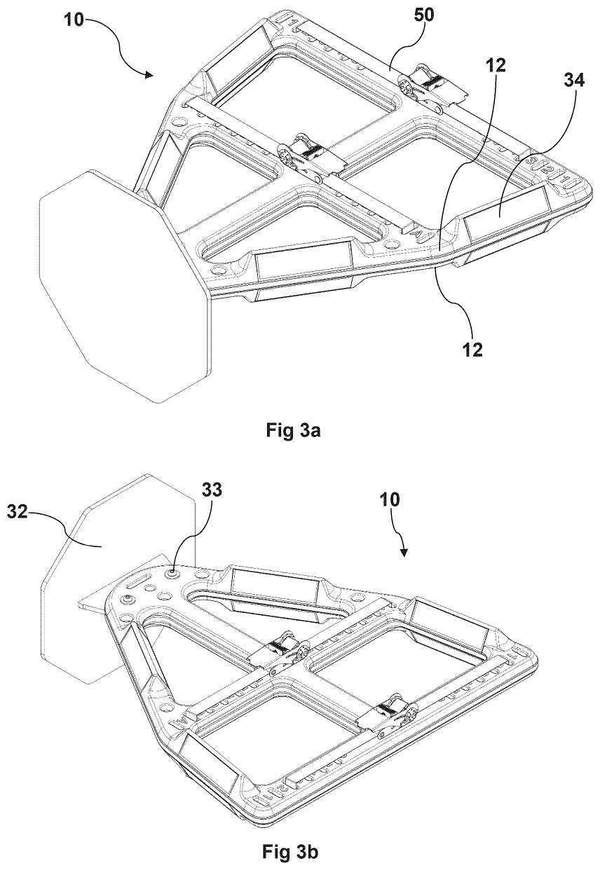

FIG. 3a illustrates an embodiment of a protective cover;

FIG. 3b illustrates a rear view of an embodiment of a protective cover;

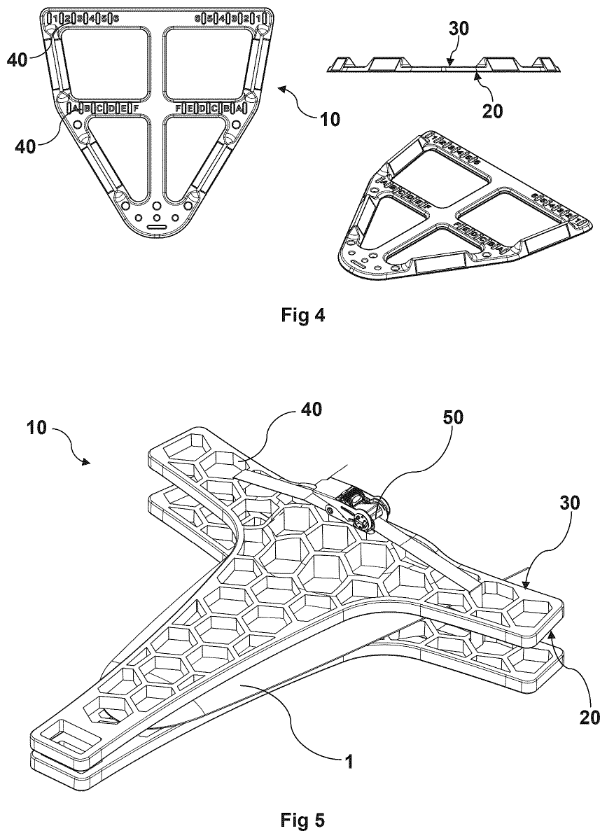

FIG. 4 illustrates an embodiment of a shell part of a protective cover;

FIG. 5 illustrates an embodiment of a protective cover fastened with a strap onto a tip of an elongated unit;

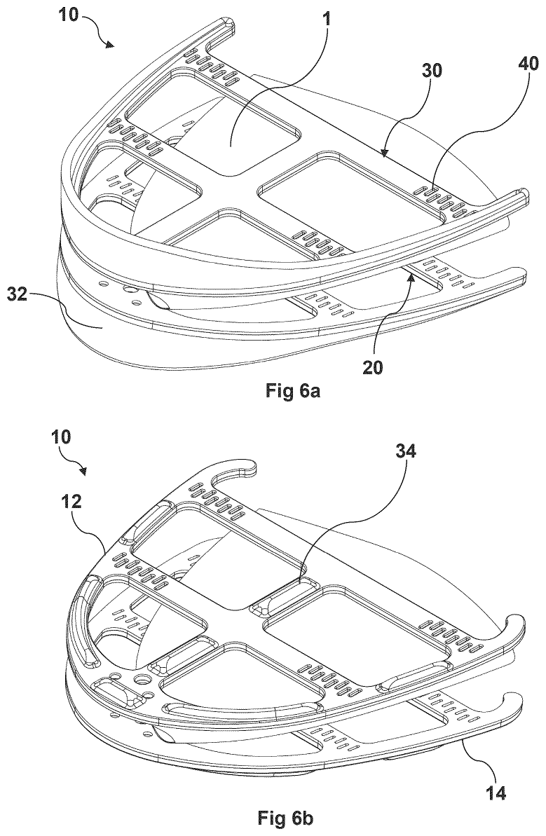

FIG. 6a illustrates an embodiment of a protective cover on a tip of an elongated unit;

FIG. 6b illustrates an embodiment of a protective cover on a tip of an elongated unit;

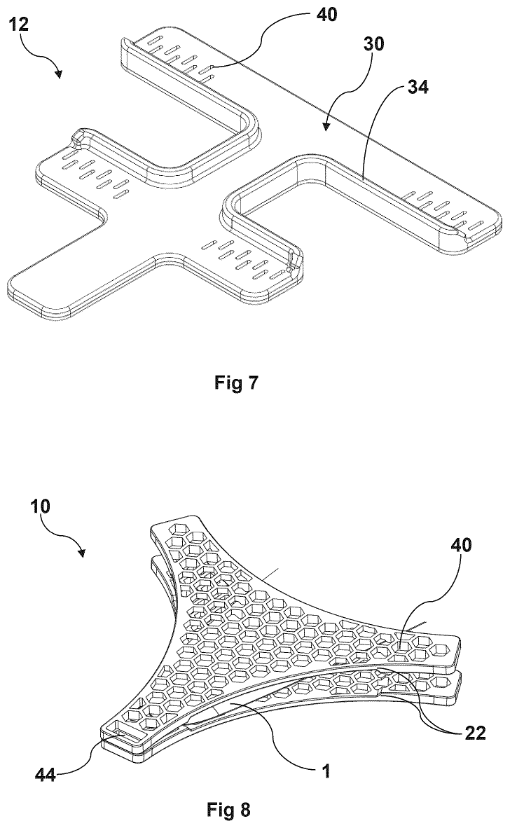

FIG. 7 illustrates an embodiment of an upper shell of a protective cover;

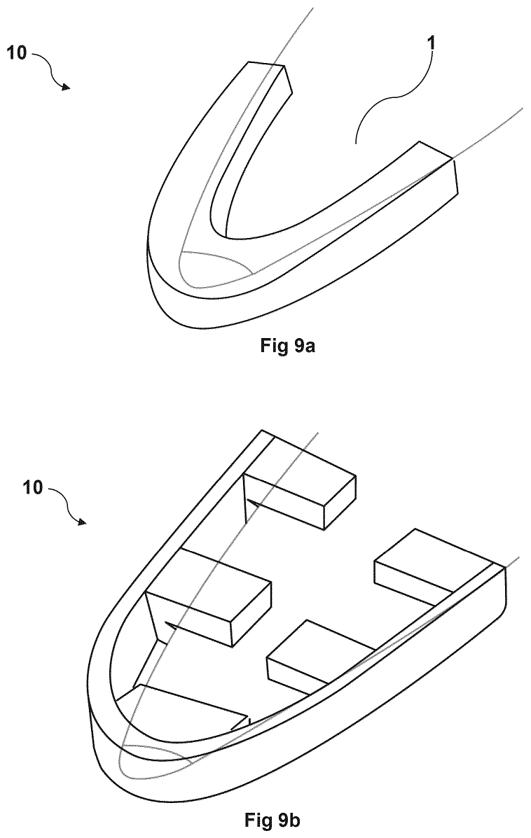

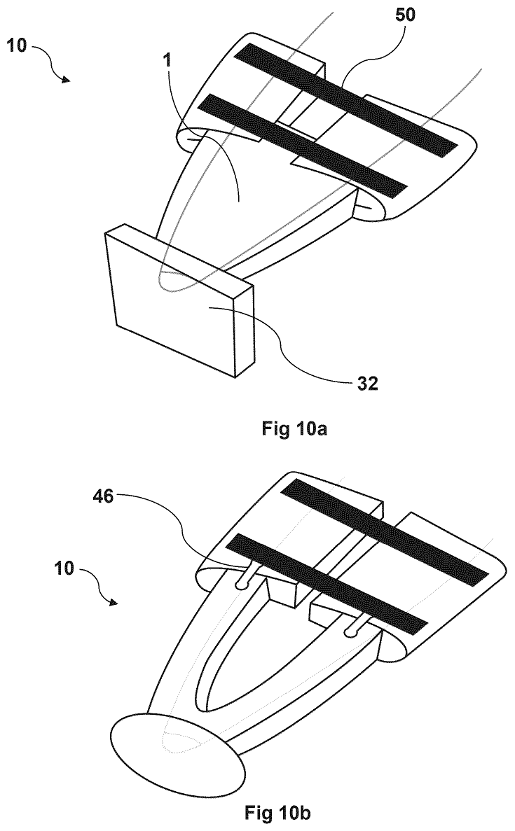

FIG. 8 illustrates an embodiment of a protective cover on a tip of an elongated unit;

FIG. 9a illustrates an embodiment of a protective cover;

FIG. 9b illustrates an embodiment of a protective cover;

FIG. 10a illustrates an embodiment of a protective cover;

FIG. 10b illustrates an embodiment of a protective cover;

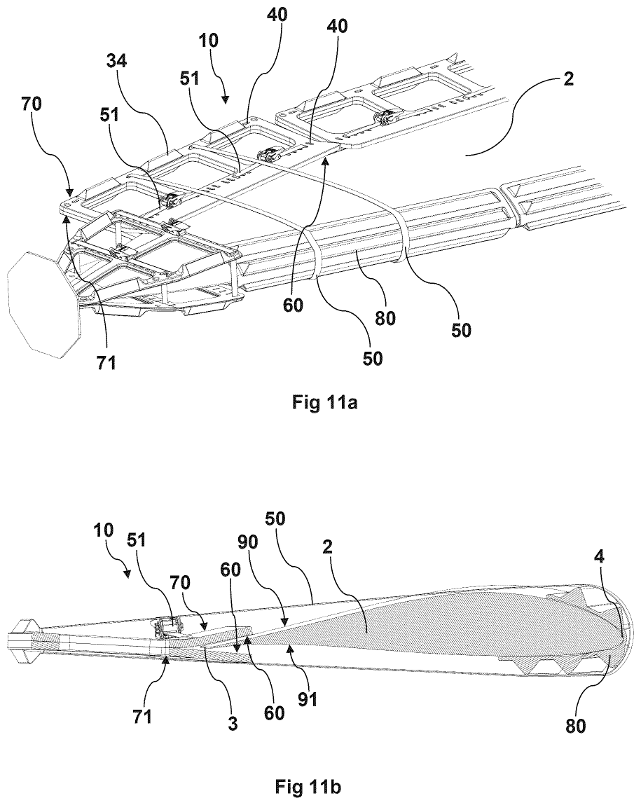

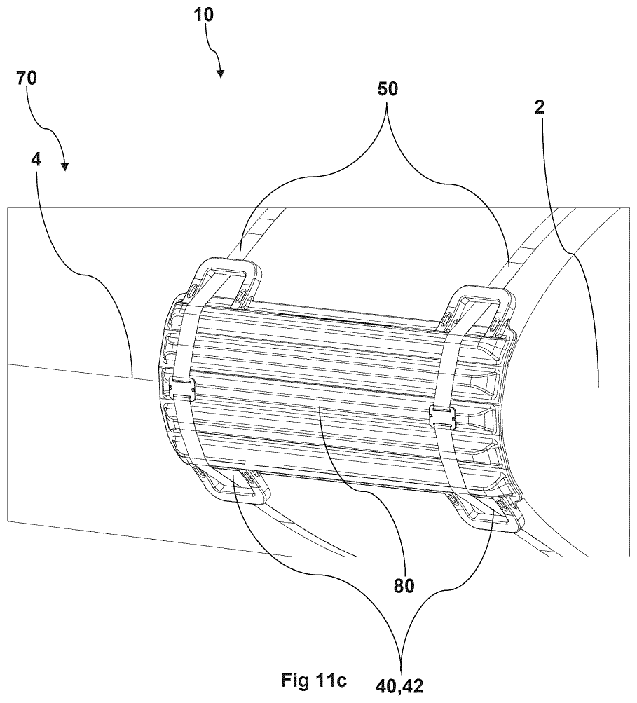

FIG. 11a illustrates an embodiment of a protective cover for protecting an edge or tip of an elongated unit;

FIG. 11b illustrates a cross sectional view of a protective cover for protecting an edge or tip of an elongated unit; and

FIG. 11c illustrates an embodiment of a protective member covering a leading edge of an elongated unit

List of Reference Numbers

| | Reference |
|---|---|
| Reference: | number: |
| Fragile tip | 1 |
| Protective cover | 10 |
| Upper shell part | 12 |
| Lower shell part | 14 |
| Elongated unit | 2 |
| Inner shell | 20 |
| Slot | 22 |
| Trailing edge | 3 |
| Outer shell | 30 |
| End-stop | 32 |
| Fastening means | 33 |
| Protrusions | 34 |
| Leading edge | 4 |
| Through-going hole | 40 |
| Through-going slit | 42 |
| Fastening means | 46 |
| Strap | 50 |
| Second strap | 51 |
| Inner surface | 60 |
| Outer upper surface | 70 |
| Outer lower surface | 71 |
| Protective member | 80 |
| Upper face | 90 |
| Lower face | 91 |

### DETAILED DESCRIPTION

FIG. 1 illustrates an embodiment of a protective cover 10 fastened to a fragile tip 1 with two straps 50. To fasten the protective cover 10 onto the fragile tip 1, the one or more straps are fed into through-going holes 40 arranged in the protective cover 10. A number of through-going holes 40 are arranged in the protective cover 10 across a width of the protective cover 10, wherein the width is perpendicular to a longitudinal extend of the fragile tip 1. The many through-going holes 40 are provided such that the protective cover 10 can accommodate a wide range of different tip sizes. One further use of the many through-going holes 40 is that the straps can be fastened tightly to provide a strong hold of the protective cover 10 onto the fragile tip 1 while ensuring that the straps 50 do not make contact with the fragile tip 1 and cause damaging of the fragile tip 1 due to e.g., the pressure of the straps or rubbing of the strap 50 due to vibrations. The protective cover 10 comprises an inner shell 20 in contact with the fragile tip 1, the inner shell 20 is made of a resilient material. The resilient material of the inner shell 20 may deform when pressed against the fragile tip 1 thereby increasing the tight hold of the protective cover 10 onto the fragile tip 1. The protective cover 10 further comprises an outer shell 30 comprising a rigid or semi rigid material, the outer shell 30 forms an upper and outer lower surface of the protective cover 10. The rigid outer shell 30 ensures that the pressure of the strap 50 is evenly distributed through the inner shell 20 and onto the fragile tip 1.

FIG. 1b illustrated a rear view of an embodiment of the protective cover 10 fastened to a fragile tip 1, the protective cover comprises an upper shell part 12 and a lower shell part 14, wherein the two shell parts surround the fragile tip 1. The upper shell part 12 and the lower shell part 14 both comprises an inner shell 20 facing the fragile tip 1 and an outer shell 30 facing outwards. The protective cover 10 is further adapted with a number of protrusions 34, the protrusions are configured to shield the fragile tip 1 from impact. The protrusions 34 are also configured to hold reflective markers or fluorescent markers and/or light sources for increasing the visibility of the protective cover during transport or storage of the fragile tip. The protrusions 34 may also be painted with a reflective or fluorescent coating. The protective cover 10 also comprises an end-stop 32 arranged at an end of the protective cover 10, wherein the end of the protective cover 10 extends outside of the furthest point of the fragile tip 1 or just outside of the end of the longitudinal extend of the fragile tip 1. The end-stop 32 is configured to shield the fragile tip 1 from impact and to provide a visual indicator of the fragile tip by having reflective markers, fluorescent markers and/or light sources. The end-stop 32 may also be painted with a reflective or fluorescent coating.

FIG. 1c illustrates a top view of an embodiment of the protective cover 10 attached to the fragile tip 1 with straps 50 arranged into the through-going holes 40. Due to the shape and size of the fragile tip 1, the straps 50 are arranged into different through-going holes 40, to ensure that a tight and protective hold is obtained around the fragile tip 1. As two straps 50 are arranged around the protective cover perpendicular to the longitudinal extend of the fragile tip and with a distance between the two straps, the resilient material of the inner shell 20 provided below the area of the two straps will conform to both the leading edge and trailing edge of the fragile tip thus ensuring that the protective cover 10 does not fall off due to vibration of the fragile tip 1 or due to wind or air resistance.

FIG. 2 illustrates an embodiment of the end-stop 32. In an embodiment the end-stop 32 comprises a plate which is shaped as an octagon, but it may also be shaped as a diamond, a square, a pentagon, a hexagon, a circle, a triangle, a cross or any such combination. The end-stop 32 also comprises a bracket configured for attaching the end-stop 32 to a protective cover 10. The end-stop 32 may also be fully integrated in the protective cover 10 by being manufactured as one piece with the protective cover 10 or by permanently fastening the end-stop 32 onto the protective cover 10 by bonding or welding the material together.

FIGS. 3a and 3b illustrates an embodiment of the protective cover 10 packed compactly together when not attached to a fragile tip 1. This embodiment also illustrates how the bracket of the end-stop 32 is attached to the protective cover 10 through fastening means 33.

FIG. 4 illustrates an embodiment of a shell part of a protective cover 10, e.g., an upper shell part or a lower shell part as illustrated in FIG. 1b. The shell part comprises an inner shell 20 facing a fragile tip, an outer shell 30 facing outwards and a plurality of through-going holes 40. The through-going holes 40 are adapted to receive a strap (not shown) for removably fastening two shell parts of the protective cover 10 to the fragile tip.

FIG. 5 illustrates an embodiment of a protective cover 10 fastened to a fragile tip 1 with a strap 50. The through-going holes 40 arranged in the protective cover receives the strap 50, by arranging the holes 40 a distance away from the edge of the fragile tip 1, the strap cannot damage the edge of the tip by being over torqued during fastening. When the strap 50 is fastened around the protective cover 10 the pressure of the fastened strap is transferred onto the rigid or semi rigid outer shell 30. The pressure onto the outer shell 30 is applied to the inner shell 20 which fastens the protective cover 10 to the tip 1 by frictional forces between the tip and the inner shell due to the resilient material of the inner shell.

FIG. 6a illustrates an embodiment of a paddle-shaped protective cover 10 arranged above and below a fragile tip 1. The protective cover 10 comprises an inner shell 20 in contact with the fragile tip 1, the inner shell 20 is made of a resilient material. The protective cover 10 further comprises an outer shell 30 comprising a rigid or semi rigid material, the outer shell 30 forms an upper and outer lower surface of the protective cover 10. The protective cover 10 also comprises a number of through-going slits 42 from the upper surface to the lower surface of the outer shell 30. The slits 42 are adapted to receive a strap (not shown) for removably fastening the two parts of the protective cover 10 to the fragile tip 1 by frictional forces between the tip and the inner shell 20 by applying force to the outer shell 30. The protective cover 10 also comprises an end stop 32, the end stop comprises an inner shell 20 and outer shell 30. The end stop 32 is adapted to hold one or more visual indicators.

FIG. 6b illustrates an embodiment of a paddle-shaped protective cover 10. The protective cover 10 comprises an upper shell part 12 and a lower shell part 14, wherein the two shell parts surround the fragile tip 1. The protective cover 10 is further adapted with a number of protrusions 34, the protrusions are configured to shield the fragile tip 1 from impact.

FIG. 7 illustrates an embodiment of an upper shell part 12 of a protective cover 10. The upper shell part 12 comprises numerous slits 42 adapted for receiving a strap (not shown) and two protrusions 34, along an inner edge of a part of the outer shell 30. The protrusions may be arranged below an area covered by the one or more straps, when the straps fasten the protective cover 10 to the tip 1, thereby the protrusions 34 raise the strap away from the outer shell 30 and thus increases downward pressure through the protrusions 34 is provided throughout the outer shell 30. Thereby, the pressure of the fastened strap is distributed more evenly throughout the whole area of the outer shell 30, instead of in a narrow area covered by the strap itself.

FIG. 8 illustrates an embodiment of a triangle-shaped protective cover 10 arranged above and below a fragile tip 1. The protective cover 10 is adapted with a plurality of through-going holes 40, adapted to receive a strap (not shown). The protective cover 10 is also provided with fastening means 44 for fastening one or more second visual indicators in a vertical direction above or below the tip 1. The protective cover 10 is also adapted with a slot 22 in the inner shell 20, the slot is provided to increase the frictional forces between the tip 1 and the inner shell 20 of the protective cover 10.

FIG. 9a illustrates an embodiment of a protective cover 10 surrounding a fragile tip 1.

FIG. 9b illustrates an embodiment of the protective cover 10.

FIG. 10a illustrates an embodiment of a protective cover 10 surrounding a fragile tip 1, in this embodiment the protective cover 10 is arranged with an end stop 32 and is fastened to the tip by a strap 50.

FIG. 10b illustrates an embodiment of the protective cover 10 in FIG. 6a, in this embodiment the protective cover is configured in two parts, one part for protecting the tip 1 and another part of protecting the edge of the elongated unit, the two parts are joined by one or more fastening means 46.

FIG. 11a illustrates an embodiment of the protective cover 10 for protecting one or more fragile edges or a tip of an elongated unit 2. This embodiment of the protective cover 10 is made of a resilient material and comprises an inner surface 60 adapted to be mounted in contact with an upper and lower face of the fragile edges or a tip of the elongated unit 2, and an outer upper surface 70 and an outer lower surface 71 facing outwards and away from the inner surface. The protective cover is adapted to extend beyond the edges or tip of the elongated unit, such that it provides a protective area around the edges or the tip. The protective cover 10 is adapted with at least one through-going hole, wherein the hole is adapted to receive a strap for removably fastening the protective cover to the elongated unit by frictional forces between the inner surface 60 and the upper and/or lower face by applying force to the outer upper surface 70 and/or the outer lower surface 71. In this illustration a further protective member 80 is arranged on the opposite edge of the elongated unit relative to the edge covered by the protective cover 10. In an embodiment, the straps 50 are arranged perpendicular to the longitudinal extend of the elongated unit, however one or more second straps 51 may also be arranged parallel to the longitudinal extend of the elongated unit in close vicinity to the edge or tip of the elongated unit 2, as such the second straps 51 may provide a clamping force onto the outer upper surface 70 and the outer lower surface 71 along the fragile edge, further ensuring that the inner surface 60 is fastened tightly and held reliably around the edge or tip of the elongated unit 2. The protective cover 10 in this embodiment is further adapted with a number of protrusions 34, the protrusions are configured to shield the fragile tip 1 from impact. The protrusions 34 are also configured to hold reflective markers or fluorescent markers and/or light sources for increasing the visibility of the protective cover during transport or storage of the fragile tip. The protrusions 34 may also be painted with a reflective or fluorescent coating.

FIG. 11b illustrates a cross sectional view of a protective cover 10 for protecting a trailing edge 3 or tip of an elongated unit 2. The protective cover 10 is arranged with the inner surface 60 in contact with an upper face 90 and lower face 91 of the trailing edge 3 of the elongated unit 2. The protective cover 10 is fastened onto the trailing edge 3 by the strap 50 surrounding the cross section of the protective cover 10 and the elongated unit 2, in this illustration the leading edge 4 is also protected by a further protective member 80, however this member is not a strict requirement for carrying out embodiments of the present invention. The further protective member 80 may encompass any one of the features of the herein disclosed protective cover and the further embodiments of the protective cover. The protective cover 10 is further fastened onto the trailing edge 3 by the second strap 51 arranged parallel to the extend of the trailing edge 3, the second strap 51 provides a clamping force onto the outer upper surface 70 and the outer lower surface 71 along the trailing edge 3, further ensuring that the inner surface 60 is fastened tightly and held reliably around the trailing edge 3.

FIG. 11c illustrates an embodiment of a further protective member 80 as described in FIGS. 11a and 11b, the protective member 80 may encompass any one of the features of the herein disclosed protective cover and the embodiments of the protective cover. The protective member 80 comprises a number of through-going holes or slits 40,42 adapted to receive a strap 50 so that the protective member 80 may be clamped to the elongated unit 2 and/or a leading edge 4 of the elongated unit 2.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A protective cover (10) for protecting one or more trailing and/or leading edges (3,4) or a tip of an elongated unit (2) with an upper face (90) and a lower face (91), wherein said protective cover (10) is made of a resilient material and comprises an inner surface (60) adapted to be mounted in contact with said upper and lower face (90,91), and an outer upper surface (70) and outer lower surface (71) facing outwards and away from the inner surface (60), wherein the protective cover is adapted to extend beyond said edges or tip of the elongated unit, wherein said protective cover comprises at least one through-going hole or slit extending from the outer upper surface (70) to the outer lower surface (71), said through-going holes (40) or slits being adapted to receive a strap (50) for removably fastening the protective cover (10) to the elongated unit (2) by frictional forces between the inner surface (60) and the upper and/or lower face (90,91) by applying force to the outer upper surface (70) and/or outer lower surface (71).

2. The protective cover (10) according to claim 1, wherein the protective cover comprises an inner shell (20) made of the resilient material and an outer shell (30) comprising a rigid or semi rigid material, where the outer shell forms the outer upper surface and outer lower surface, whereby the strap (50) removably fastens the protective cover (10) to the elongated unit (2) by frictional forces between the edges or the tip of the elongated unit and the inner shell (20) by applying force to the outer shell (30).

3. The protective cover (10) according to claim 1 or 2, wherein the resilient material is reinforced with internal reinforcement, said internal reinforcement comprises a rigid or semi rigid material for increasing the durability and strength of the resilient material.

4. The protective cover (10) according to claim 3, wherein the internal reinforcement is a plastic, metal, wood and/or a composite material.

5. The protective cover (10) according to claim 3 or 4, wherein the internal reinforcement is arranged in a direction parallel and/or perpendicular with a longitudinal direction of the elongated unit (2).

6. The protective cover according to any one or more of claims 3-5, wherein the internal reinforcement is arranged in a mesh pattern.

7. The protective cover (10) according to any one or more of claims 1-6, wherein the protective cover comprises one or more visual indicator.

8. The protective cover (10) according to claim 7, wherein the one or more visual indicator comprises a reflective material, a fluorescent material and/or one or more light sources.

9. The protective cover (10) according to any one or more of claims 1-8, wherein the protective cover comprises an upper shell part (12) and a lower shell part (14), wherein the upper shell part and the lower shell part are configured to be arranged opposite each other with the elongated unit (2) placed in-between the two parts (12,14).

10. The protective cover (10) according to any one or more of claims 1-9, wherein the resilient material is polyurethane (PUR).
